(19) United States
(12) Patent Application Publication
(10) Pub. No.: US 2006/0239369 A1
(43) Pub. Date: Oct. 26, 2006

(54) Methods and systems for transmission channel drlrction in wireless communication

(75) Inventor: Chang-Hung Lee, Yunlin (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/409,965

(22) Filed: Apr. 25, 2006

(30) Foreign Application Priority Data
Apr. 25, 2005 (TW) 94113076

(51) Int. Cl. H04K 1/10

(52) U.S. Cl. 375/260

(57) ABSTRACT

A channel selection method applied at wireless communication. A transmitter selects a first transmission channel to carry test pattern. A receiver receives and compares the test pattern with stored data, and calculates a first signal quality. When the first signal quality exceeds a target value, the receiver sets the first transmission channel as an operating channel.

### BACKGROUND

The invention relates to wireless transmission techniques, and more particularly, to selection of transmission channel in wireless network.

As wireless network grows, transmitting data via wireless network becomes a major issue in network techniques. In the field of networking, there is potential for improving wirelessly transmitting video/audio data.

In wireless communication, signal quality is frequently compromised by transmitters and receivers choosing different channels for communication there between.

FIG. 1 shows transmission of video/audio in a wireless network. Typically, transmission channels for the transmitter and receiver are chosen manually. This can be inconvenient when the transmitter and receiver are in separated locations. Alternatively, transmitter and the receiver select the most sensitive transmission channels automatically. However, this solution is ineffective for Audio/Video (AV) streaming data, which requires signal stability rather than sensitivity. Further, in some cases, when transmitter and receiver are in different locations, the best channel for the transmitter may be different from the best channel for receiver. Signal quality is clearly inferior to that transmitted on the same channel, especially when transmitting AV streaming data in real time.

### SUMMARY

The invention provides a method for transmission channel selection by a transmitter and a receiver, comprising: selection of a first transmission channel to transmit a test pattern, the receiver receiving the test pattern, comparing stored data with the received test pattern, and determining a first signal quality. If the first signal quality is greater or equal to a target value, the first transmission channel is set as an operating channel. The stored data corresponds to the test pattern. The first signal quality can be calculated as a signal-to-noise ratio (SNR), bit-error rate, or data throughput.

The invention further provides a channel selection system, comprising a transmitter and a receiver. The transmitter comprises a first channel selector and a first transceiver. The first channel selector selects a first transmission channel from a plurality of available transmission channels. The first transceiver transmits a test pattern on the first transmission channel. The receiver comprises a second transceiver, a processor, and a second channel selector. The second transceiver receives the test pattern. The processor calculates a first signal quality of the first transmission channel according to the received test pattern. When the first signal quality greater or equal to a target value, the second channel selector sets the first transmission channel as an operating channel, and sends a command to the first transceiver to also set the first transmission channel as the operating channel.

### BRIEF DESCRIPTION OF THE DRAWINGS

FIG. 1 is a diagram of audio/video data transmission in a wireless network;

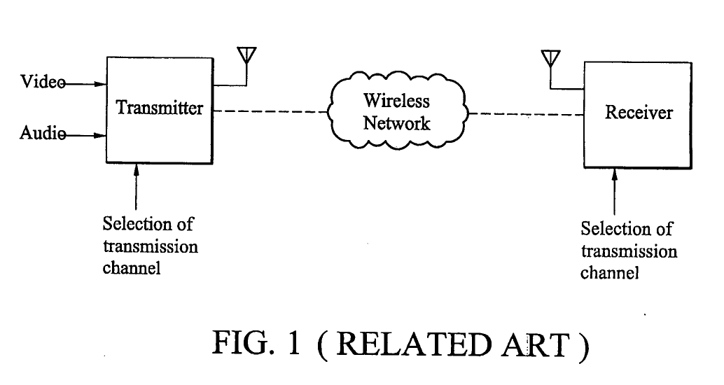

FIG. 2 is a flowchart of a method for selecting a transmission channel according to embodiments of the invention; and

FIG. 3 shows a wireless transmission system according to an embodiment of the invention.

### DETAILED DESCRIPTION

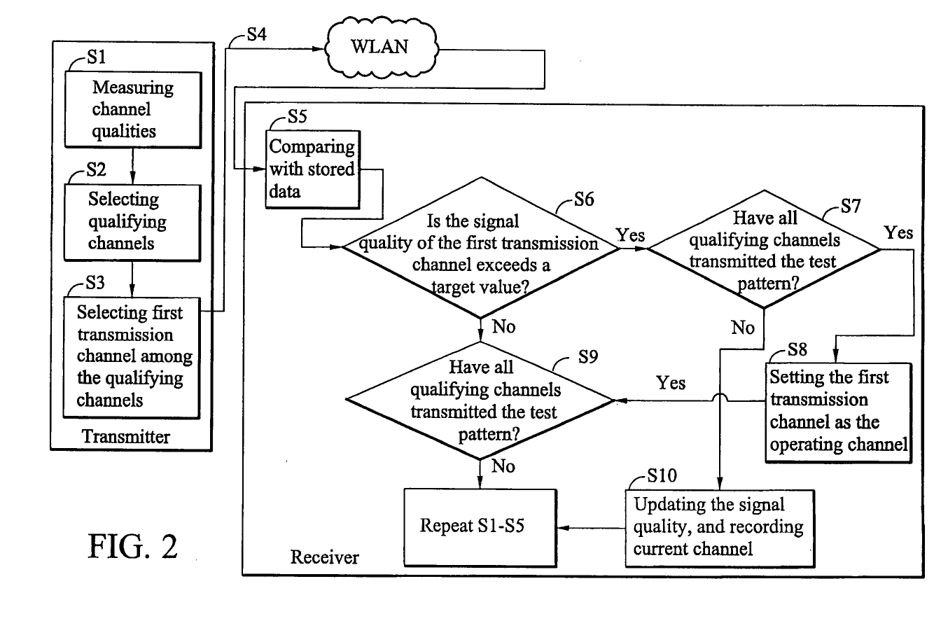

FIG. 2 is a flowchart of a method for selecting a transmission channel according to embodiments of the invention. In step S1, a transmitter measures channel qualities of all available transmission channels. The transmitter selects qualifying transmission channels with signal-to-noise ratio (SNR) less than a threshold SNR (step S2). The transmitter further selects a first transmission channel from qualifying transmission channels, in step S3. For example, if 4 transmission channels A, B, C, and D, are available, threshold SNR is 3, and the respective SNRs of the four channels are 7, 1, 10, and 4, the transmitter selects a first transmission channel among qualifying transmission channels A, C, and D. After selecting the first transmission channel, the transmitter transmits a test pattern, in step S4. In this example, the transmitter selects channel A as the first transmission channel, and transmits a test pattern via thereon.

When receiving the test pattern, the receiver compares the received test pattern with stored data, and calculates the signal quality according to the comparison result, in step S5. The stored data corresponds to the test pattern sent by the transmitter. For example, the test pattern may be the same as the stored data. There are 4 possible comparison results, detailed as following:

1. If the signal quality (in this embodiment, SNR) greater than a target value but not all qualifying transmission channels have transmitted the test pattern, the receiver updates the target value with the signal quality of the current first transmission channel, records the channel number of the current first transmission channel (in this case, “channel A”), in step S10, and repeats steps S1-S5.

2. If the signal quality is less then the target value and not all transmission channels have transmitted the test pattern, as in steps S6-No and S7-No, repeat steps S1-S5.

3. If the signal quality greater than the target value and all transmission channels have transmitted the test pattern, the receiver sets the current first transmission channel as operating channel. The transmitter and receiver transmits/receives video or audio data via the operating channel.

4. If the signal quality is less then the target value and all transmission channels have transmitted the test pattern, in steps S6-No and S7-Yes, then the transmitter and receiver are set to communicate via the channel recorded in step S10.

For example, if there are 3 qualifying transmission channels, channel A, C, and D, and the target SNR is originally set as 5, and measured SNR of channel A is 7, exceeding target SNR 5, the target SNR is updated to 7, and “channel A” is recorded, and steps S1-S5 are repeated. Next, the transmitter sends test pattern via channel B. Measured SNR of channel B is 10, exceeding target SNR 5, thus the target SNR is updated to 10, and “channel B” is recorded to replace “channel A”, and steps S1-S5 are repeated. The next measured channel is channel D. The SNR of channel D, 4, is less than the target SNR. In this time, all qualifying transmission channels have been measured, so the last recorded channel “channel B” is set as the operating channel. The transmitter and receiver transmits/receives video or audio data via the operating channel. If there are only one qualifying transmission channel, the transmitter sends test pattern via the channel. If measured SNR is greater than the target SNR. The channel is set as the operating channel.

In this embodiment of the invention, while signal quality may be SNR, bit-error rate, throughput, and other values can be used. The reason of signal quality can be throughput is that when the number of transmitter or receiver using the channel grows, throughput per transmitter/receiver may decreases. Thus, consistent throughput represents an index of channel quality.

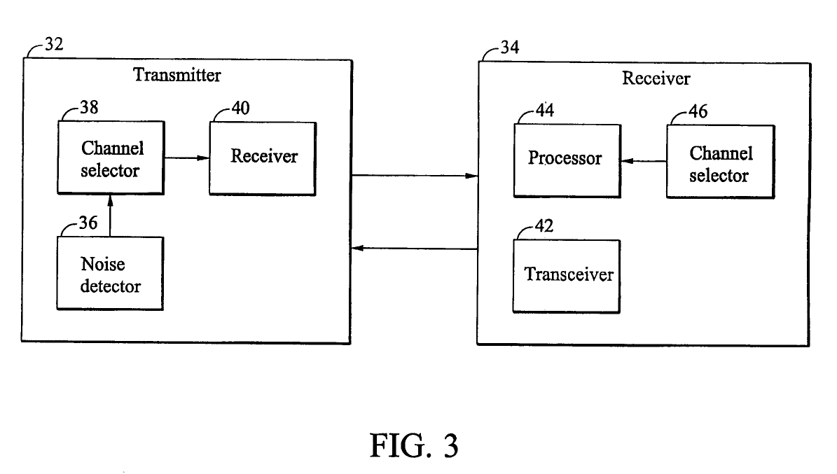

FIG. 3 shows a wireless transmission system according to an embodiment of the invention. The system includes a transmitter 32 and a receiver 34. The transmitter 32 includes a noise detector 36, a first channel selector 38, and a transceiver 40. The noise detector 36 measures noise of the channels. The first channel selector 38 selects qualifying transmission channels according to the noise value. The noise values of the qualifying transmission channels are less than a threshold noise value. The first channel selector 38 further selects a first transmission channel among the qualifying transmission channels. After the first transmission channel is selected, the first transceiver 40 transmits a test pattern via the first transmission channel. In this embodiment of the invention, the test pattern is video/audio data, as Joint Photographic Experts Group(JPEG), Moving Pictures Experts Group(MPEG), Audio Video Interleaved(AVI), or other still/moving image standards.

The receiver 34 includes a second transceiver 42, a processor 44, and a second channel selector 46. The second transceiver 42 receives the test pattern. The processor 44 measures a signal quality of the first transmission channel according to the received test pattern and the stored data. The stored data corresponds to the test pattern. The second channel selector 46 sets the first transmission channel as an operating channel when the signal quality exceeds a target value, and directs the first transceiver 32 via the second transceiver 42 set the first transmission channel as operating channel.

The first channel selector 38 of transmitter 32 selects each qualifying channel, and transmits the test pattern through the first transceiver 40. The processor 44 of the receiver 34 determines signal quality of the qualifying transmission channels. When the signal quality exceeds the target value, the processor 44 updates the target value as the current signal quality. The receiver 32 confirms via the selected channel.

In other embodiments of the invention, the transmitter 32 and the receiver 34 can use spread spectrum coding, such as Code Division Multiple Access (CDMA), 802.11, or other protocol.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for selecting a channel between a transmitter and a receiver, comprising:
selecting a first transmission channel from a plurality of transmission channels and transmitting a test pattern by the transmitter;
receiving the test, pattern, comparing the received test pattern with stored data for calculating a first signal quality by the receiver; and
when the first signal quality greater or equal to a target value, setting the first transmission channel is set as an operating channel.

2. The method as claimed in claim 1, further comprising:
measuring respective noise values corresponding to the plurality of transmission channels by the transmitter;
selecting a plurality of qualifying transmission channels from the plurality of transmission channels, whereby the noise values of the qualifying transmission channels are less than a threshold noise value; and
selecting the first transmission channel from the qualifying transmission channels.

3. The method as claimed in claim 2, wherein the receiver sends a command the transmitter to confirm communicating by the first transmission channel.

4. The method as claimed in claim 3, wherein the transmitter and the receiver use Spread Spectrum coding.

5. The method as claimed in claim 1, further comprising:
transmitting the test pattern on each transmission channel by the transmitter; and
measuring a signal quality for each transmission channel by the receiver, the first signal quality greater or equal to the target value.

6. The method as claimed in claim 1, further comprising, for each unselected channel:
selecting a transmission channel and transmitting the test pattern thereon by the transmitter;
upon the receipt of the test pattern, the receiver comparing the stored data therewith to ascertain the first signal quality; and
when the first signal quality exceeds the target value, updating the target value.

7. The method as claimed in claim 1, wherein the signal quality is one of bit-error rate, signal-to-noise ratio and throughput.

8. A channel selection system, comprising:
a transmitter, comprising:
a first channel selector, selecting a first transmission channel from a plurality of transmission channels; and
a first transceiver, transmitting a test pattern on the first transmission channel; and
a receiver, comprising:
a second transceiver, receiving the test pattern;
a processor, calculating a first signal quality for the first transmission channel according to the received test pattern; and
a second channel selector, when the first signal quality exceeds the target value, the first transmission channel as an operating channel, and sending a command to the first transceiver by the second transceiver to set the first transmission channel as the operating channel.

9. The system as claimed in claim 8, the transmitter further comprising:
a noise detector, measuring respective noise values of the plurality of transmission channels, wherein the first channel selector selects a plurality of qualifying channels from the transmission channels, the noise values of the qualifying channels less than a target noise value, the first channel selector selecting the first transmission channel from the qualifying channels.

10. The system as claimed in claim 8, wherein the transmitter and the receiver communicate with each other via the first transmission channel.

11. The system as claimed in claim 8, wherein the transmitter and the receiver communicate with Spread Spectrum coding.

12. The system as claimed in claim 8, wherein the first channel selector selects each transmission channel to transmit the test pattern via the first transceiver, the processor calculates the first signal quality, and the first signal quality exceeds the signal values.

13. The system as claimed in claim 12, wherein when the first signal quality exceeds the target value but not all qualifying transmission channels have transmitted the test pattern, the processor updates the target value by the first signal quality.

14. The system as claimed in claim 10, wherein the test pattern is video/audio data.

15. The system as claimed in claim 8, wherein the signal quality is one of bit error rate, signal-to-noise ratio and throughput.
